(19) United States
(12) Patent Application Publication
(10) Pub. No.: US 2008/0261015 A1
(43) Pub. Date: Oct. 23, 2008

(54) Long molded article

(75) Inventors: Kurato Okajima, Aichi-ken (JP); Masanori Aritake, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/892,946

(22) Filed: Aug. 28, 2007

(30) Foreign Application Priority Data
Aug. 30, 2006 (JP) P2006-233486

(51) Int. Cl. B32B 5/18

(52) U.S. Cl. 428/304.4

(57) ABSTRACT

The long molded article having a decoration layer of a thermoplastic elastomer and molded by extrusion molding, wherein the decoration layer contains 2 to 10 parts by weight of an OBSH-based foaming agent and 3 to 10 parts by weight of an one or more organic acid salt selected from an ascorbic acid salt, an acetic acid salt, a gluconic acid salt, a glutamic acid salt, a malic acid salt, and a succinic acid salt.

### BACKGROUND OF THE INVENTION

1. Field of the Invention

This invention relates to a long molded article having on its surface a decoration layer made from a thermoplastic elastomer foamed body having a uniform and fine foaming cell diameter.

Examples of specific applicable field include a long molded article to be molded by extrusion molding, such as an automobile weather strip for sealing a seam between a door of an automobile, an open/close member of a trunk lid, and the like and an opening of an automobile body.

2. Related Art

The long molded article such as an automobile weather strip is molded by extrusion molding. In this case, after extrusion-molding a material such as a synthetic rubber and a thermoplastic elastomer, the synthetic rubber, for example, is vulcanized in a vulcanizing tank to obtain the long molded article. The long molded article is cut into a predetermined size, and then a corner or the like of the cut molded article is molded by using a die to obtain a product such as the automobile weather strip (see Patent Publication 1, for example).

A main body of the automobile weather strip is generally formed from the synthetic rubber or the thermoplastic elastomer and is usually black due to carbon black that is used as a reinforcing agent for the components.

However, for the purposes of blending in with interior parts of the automobile and improving appearance, there has been a demand for products varied in surface pattern and color.

To meet such demand, a surface material such as a cloth is attached to a surface of the long molded article main body obtained by extrusion molding of the automobile weather strip, or a color decoration layer is provided on the long molded article main body surface. However, in the case of attaching the surface material such as a cloth, the production process is complicated, and the cost is increased.

In order to provide the decoration layer on the long molded article main body surface, as shown in FIG. 2, a weather strip main body 111 which is the long molded article main body obtained by extrusion molding by using an extrusion molding machine 1 and vulcanization in a vulcanizing tank 2 is prefoamed to be bento into a little angular shape by using a primary prefoaming machine 3, and then a surface treatment for improving an adhesion property is performed on the weather strip main body 111 by using an adhesive agent or a primer coating machine 4 or by colonna discharge, plasma processing, or the like. In the case where compatibility between the weather strip main body 111 and the decoration layer 117 is sufficient to allow heat welding, it is possible to omit the surface treatment process. The decoration layer 117 is extrusion-molded into a sheet-like shape on the weather strip main body 111 by using an extrusion dice 9 connected to an extrusion molding machine 5. The sheet-like decoration layer 117 obtained by extrusion is brought into pressure-contact with the weather strip main body 111 by using a laminating machine 6 to adhere the decoration layer 117 to the weather strip main body 111. An opening trim weather strip 110 cooled in a cooling tank 7 is drawn by a drawing machine 8 (see Patent Publication 2, for example). A secondary bending process for bending a trim part so as to form a substantially U-shaped section is performed when the opening trim weather strip is passed through the laminating machine 6.

After that the opening trim weather strip 110 is cut into a predetermined size, and then a corner thereof or the like is molded by using a die when so required to obtain a product.

In this case, as shown in FIG. 4, a surface of the decoration layer 117 is not black unlike the weather strip main body 111 and varied in color in order to be suppressed in brilliance, to achieve sedate appearance to blend in with the interior component parts inside the automobile, and to improve texture. As the decoration layer 117, a foamed material made from a thermoplastic elastomer is used, for example (see Patent Publication 3, for example).

However, the decoration layer 117 having an excellent color due to the thermoplastic elastomer foamed material is subject to reddish discoloration when left to stand for a certain period of time under a specific environment, and the appearance thereof is considerably deteriorated in some cases (see Patent Publication 4, for example).

The discoloration is attributable to alkalization of the decoration layer 117, and it is considered that the alkalization is caused by chemical components contained in the weather strip main body 111 and the decoration layer 117. Particularly, the discoloration is attributable to a strong alkaline property of a decomposition residue of a foaming agent after the foam molding.

A decomposition residue after foam molding of a foaming agent can be acidic, alkaline, and the like, and it has heretofore been necessary to use a sodium hydrogen carbonate-based foaming agent of which a decomposition residue is strong alkaline in order to obtain a fine and high density foam appearance wherein a foaming cell diameter is small. Therefore, it has been difficult to prevent the discoloration of the decoration layer 117 under the specific environment.

[Patent Publication 1] JP-A-6-106597

[Patent Publication 2] JP-A-8-174620

[Patent Publication 3] JP-A-2001-246991

[Patent Publication 4] JP-A-2004-346171

Therefore, it is necessary to easily and reliably obtain a long molded article having a decoration layer blending in with interior component parts of an automobile and having a fine and high density foam appearance and a luxury surface pattern.

In order to attain the above object, the first aspect of this invention provides a long molded article comprising a decoration layer of a thermoplastic elastomer foamed material, wherein the decoration layer contains 2 to 10 parts by weight of 4,4′-oxybis-benzene-sulfonylhydrazine (hereinafter referred to as OBSH)-based foaming agent and 3 to 10 parts by weight of an organic acid salt.

According to the first aspect of this invention, since the long molded article comprises the decoration layer of the thermoplastic elastomer foamed material, it is possible to select a color and a material of the decoration layer separately from a long molded article main body as well as to easily change the color and the like of the decoration layer in accordance with an environment in which the long molded article is to be used, thereby realizing a preferable design.

Since the decoration layer contains 2 to 10 parts by weight of the OBSH-based foaming agent and 3 to 10 parts by weight of the organic acid salt, the organic acid salt behaves as a core of the foaming, thereby enabling to obtain the decoration layer having a small foaming cell diameter, fine and high density foam appearance, a luxury surface pattern, and a soft texture. Also, as compared to a sodium hydrogen carbonate-based foaming agent that has heretofore been used for obtaining a foamed material having a fine foaming density, the OBSH-based forming agent and the organic acid salt makes a decomposition residue of the OBSH-based foaming agent to acidic after the foam molding to prevent discoloration of the decoration layer.

The second aspect of this invention provides the long molded article, wherein the thermoplastic elastomer foamed material is molded by extrusion molding and has an average foaming cell diameter of 100 to 300 μm.

According to the second aspect of this invention, since the decoration layer is provided integrally with the long molded article main body, it is possible to form the decoration layer simultaneously with the extrusion molding of the long molded article or continuously after the extrusion molding in an identical process step. Since the thermoplastic elastomer foamed material serving as the long molded article has the average foaming cell diameter of 100 to 300 μm, the surface of the decoration layer has an appearance having a fine and high density relief pattern, thereby realizing a luxury surface brilliance and a soft texture.

The third aspect of this invention provides the long molded article, wherein the organic acid salt is at least one selected from an ascorbic acid salt, an acetic acid salt, a gluconic acid salt, a gultamic acid salt, a malic acid salt, and a succinic acid salt.

According to the third aspect of this invention, since the organic acid salt is at least one selected from the ascorbic acid salt, the acetic acid salt, the gluconic acid salt, the gultamic acid salt, the malic acid salt, and the succinic acid salt, the organic acid salt behaves as a core of the forming when the OBSH-based foaming agent foams to give a fine foaming cell diameter. Also, since the organic acid is a relatively strong acid, it is possible to maintain acidity of the decoration layer when a decomposition residue of the foaming agent is generated, thereby preventing discoloration of the decoration layer.

The fourth aspect of this invention provides the long molded article, wherein the organic acid salt is sodium acetate.

According to the fourth aspect of this invention, since the organic acid salt is sodium acetate, it is possible to maintain acidity of the decoration layer when a decomposition residue of the OBSH-based foaming agent is generated, thereby preventing discoloration of the decoration layer. Also, the sodium acetate behaves as a core of the foaming when the OBSH-based foaming agent foams, thereby achieving a finer foaming cell diameter.

The fifth aspect of this invention provides the long molded article, wherein the decoration layer contains the OBSH-based foaming agent in an amount of 4 to 8 parts by weight and the organic acid salt in an amount of 10 to 3 parts by weight, the organic acid salt content being adjusted in such a manner that the organic acid salt content is increased when the foaming agent content is small.

According to the fifth aspect of this invention, the decoration layer contains the OBSH-based foaming agent in an amount of 4 to 8 parts by weight and the organic acid salt in an amount of 10 to 3 parts by weight, the organic acid salt content being adjusted in such a manner that the organic acid salt content is increased when the foaming agent content is small. Since the amount of the foaming agent is reduced to increase the content of the organic acid salt serving as the core of foaming, it is possible to obtain a large amount of fine and uniform foaming cells.

The sixth aspect of this invention provides the long molded article, wherein the decoration layer of the thermoplastic elastomer foamed body is a decoration layer of an automobile weather strip and provided on a trim part having a substantially U-shaped section of a weather strip main body and/or an upper surface of a cover lip extending from the trim part, and the weather strip main body is formed from ethylene/α-olefin/diene non-conjugated polymer (EPDM).

According to the sixth aspect of this invention, the decoration layer of the thermoplastic elastomer foamed body is a decoration layer of an automobile weather strip and provided on a trim part having a substantially U-shaped section of a weather strip main body and/or an upper surface of a cover lip extending from the trim part, and the weather strip main body is formed from ethylene/α-olefin/diene non-conjugated polymer (EPDM). Therefore, it is possible to provide the decoration layer on a part of a surface of the weather strip to be attached to an opening of a door or the like of an automobile and observed from the inside of the automobile as well as to provide the weather strip with the decoration layer having a color and a pattern blending in with interior products inside the automobile. Also, it is possible to form a luxury pattern having a sedate brilliance by suppressing glossiness on the surface of the decoration layer as well as to impart a soft texture to the surface by the fine foaming.

Since the weather strip main body is formed from the EPDM rubber and the decoration layer is formed from the thermoplastic elastomer, it is possible to attach the weather strip main body and the decoration layer with each other in the case where the thermoplastic elastomer is olefin-based. In the case of continuously providing the decoration layer on the automobile weather strip main body obtained by vulcanizing the EPDM rubber, it is possible to attach the decoration layer to the vulcanized and heated automobile weather strip main body easily and without heating.

Also, in the case of using the thermoplastic elastomer, since vulcanization is not required after the formation of the surface pattern of the extruded decoration layer, the formed pattern is not erased, and the relief is not diminished.

Further, since the weather strip main body is formed from EPDM, the weather strip main body has a sufficient rigidity, flexibility, and resiliency for retaining the shape due to the vulcanization, and it is possible to give products that are excellent in weather resistance and inexpensive. Since the decoration layer is formed from the olefin-based thermoplastic elastomer which is the olefin-based material that is in common with the long molded article main boy that is formed from EPDM, it is possible to attach the decoration layer easily and firmly.

Also, since the decoration layer is made from the thermoplastic elastomer, it is unnecessary to vulcanize the decoration layer after the molding, thereby maintaining the flexibility after attachment to the EPDM.

This invention enables to select the color and the material of the decoration layer separately from the long molded article as well as to change the color and the like of the decoration layer easily in accordance with an environment in which the long molded article is to be used. Since the decoration layer contains 4 to 12 parts by weight of the OBSH-based foaming agent and 3 to 10 parts by weigh of the organic acid salt, the organic acid salt behaves as the core of foaming, the decoration layer has foam appearance of a small foaming cell diameter and a fine and high density and a luxury surface pattern, and the discoloration of the decoration layer is prevented by making the decomposition residue of the OBSH-based foaming agent to acidic.

### BRIEF DESCRIPTION OF THE DRAWINGS

FIG. 1 is a diagram showing a shape of a section of an automobile weather strip according to one embodiment of this invention.

FIG. 2 is a schematic diagram showing a step for extrusion-molding a decoration layer in the vehicle weather strip according to the embodiment of this invention.

FIG. 3 is a sectional view showing a part of a head of a molding machine and an extrusion dice for extrusion-molding the decoration layer of FIG. 2.

FIG. 4 is an enlarged perspective view showing a part of the decoration layer of the vehicle weather strip according to the embodiment of this invention.

### DETAILED DESCRIPTION OF THE PREFERRED EMBODIMENTS

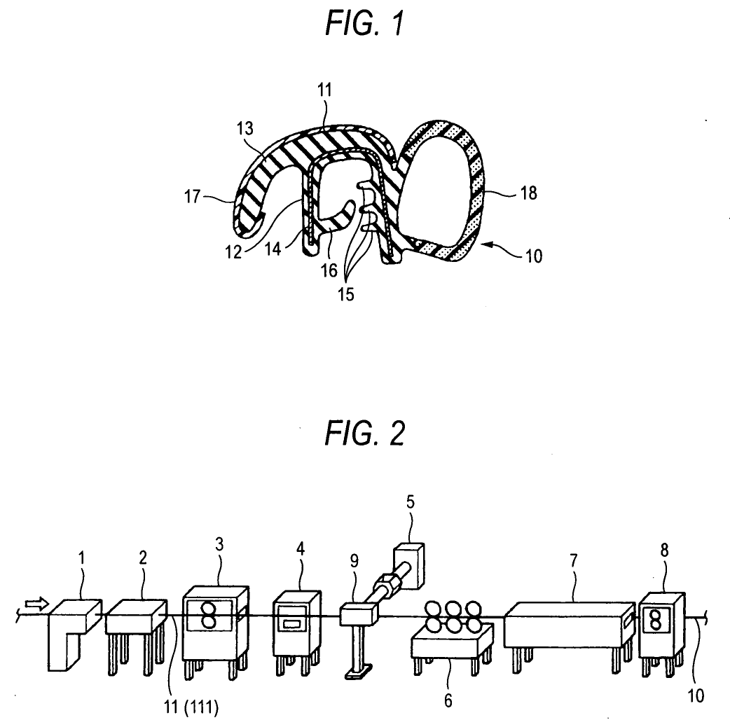

On embodiment of this invention will be described based of FIGS. 1 to 4. Though a case of applying this invention to an opening trim weather strip 10 of an automobile will be described by way of example in the embodiment, this invention is applicable to long molded articles to be molded by extrusion molding.

FIG. 1 is a sectional view showing the automobile opening trim weather strip 10 to be produced by a molding method of this embodiment. The opening trim weather strip 10 is formed of a weather strip main body 11 having a trim part 12, a cover lip 13, and a hollow sealing part 18 and a decoration layer 17 provided on the trim part 12 and an upper surface of the cover lip 13.

The trim part 12 has a substantially U-shaped section, and an inserted member 14 is embedded into an inner part of the trim part 12. The cover lip 13 extending to a vehicle interior side is provided on an upper part of the trim part 12. A plurality of vehicle exterior holding lips 15 and a vehicle interior holding lip 16 are provided on an inner surface having the substantially U-shaped section of the trim part 12. A flange of a door or a vehicle body opening rim is inserted into the U-shaped inner part of the trim part 12 to be retained by the vehicle exterior side holding lips 15 and the vehicle exterior holding lip 16, so that the opening trim weather strip 10 is attached to the flange.

The trim part 12 and the cover lip 13 are formed from a solid material or a microfoamed material of a rubber, a thermoplastic elastomer, a soft synthetic resin, or the like, and the hollow sealing part 18 is formed from a sponge material of a rubber or a thermoplastic elastomer for flexibility and resiliency. As the rubber, an ethylene/α-olefin/diene non-conjugated polymer or an ethylene/propylene/diene ternary non-conjugated polymer (EPDM rubber), each of which is a synthetic rubber, may be used.

The decoration layer 17 is fixed to the upper surface of the trim part 12 and the upper surface of the cover lip 13. The upper surfaces of the trim part 12 and the cover lip 13 are observed from the inside of the vehicle. Therefore, it is necessary to change a surface pattern of the decoration layer 17 in accordance with a color and brilliance of the interior of the vehicle from the design point of view, and the decoration layer 17 having the surface pattern blending in with the interior is used.

The decoration layer 17 is formed from a foamed material of a thermoplastic elastomer. As the thermoplastic elastomer, an olefin-based thermoplastic elastomer may preferably be used in the case where the weather strip main body 11 is formed from the EPDM rubber in order to realize strong attachment between the weather strip main body 11 and the decoration layer 17.

As described later in this specification, the decoration layer 17 in this embodiment is obtained by forming a sheet-like material having a substantially constant thickness by extrusion molding and bringing the sheet-like material into close contact with the opening trim weather strip 10 in a longitudinal direction of the opening trim weather strip 10 to be in the form of a strip. As shown in FIG. 1, one end in a widthwise direction of the decoration layer 17 is provided in the vicinity of a boundary between the trim part 12 and the hollow sealing part 18 to cover the trim part 12. The other end in the widthwise direction of the decoration layer 17 covers a tip of the cover lip 13 to enclose the tip, so that the decoration layer 17 perfectly covers a vehicle interior side of the cover lip 13 and the trim part 12.

FIG. 4 is an enlarged perspective view showing a part of the decoration layer 17 covering the cover lip 13.

In FIG. 4, the surface of the decoration layer 17 is provided with a fine relief pattern formed by foaming cells provided on the surface through foaming of the decoration layer 17. The relief pattern is provided on a substantially entire surface of the decoration layer 17. By the relief pattern, a glossiness of the surface of the decoration layer 17 is suppressed, thereby creating luxury looking and improving a texture.

An average foaming cell diameter of the decoration layer 17 is 100 to 300 μm to form a fine foamed layer, and the decoration layer 17 contains an OBSH-based foaming agent and 3 to 10 parts by weight of an organic acid salt. The decoration layer 17 may contain 2 to 10 parts by weight of the OBSH-based foaming agent, an antioxidant, a light stabilizer, and an ultraviolet absorber described below and calcium stearate, talc, and the like may also be contained in the decoration layer 17.

The OBSH-based foaming agent is a foaming agent containing 4,4′-oxybis-benzene-sulfonylhydrazine as a main component and generates a nitrogen gas and water vapor when decomposed.

The organic acid salt may preferably be one or more selected from an ascorbic acid salt, an acetic acid salt, a gluconic acid salt, a gultamic acid salt, a malic acid salt, and a succinic acid salt. The content of the organic acid salt may preferably be 3 to 10 parts by weight as described above even when two or more of the organic acid salts are used.

In the case where the organic acid salt content is less than 3 parts by weight, it is difficult to form a large number of the fine foaming cells in the decoration layer 17, and there is a fear of failing to satisfactorily prevent the discoloration of the decoration layer 17. In the case where the organic acid salt content exceeds 10 parts by weight, the number of the fine foaming cells is increased too much so that parts of the foaming cells are connected to form large foaming cells, thereby failing to obtain the predetermined fine and uniform foaming cells as well as undesirably increasing the cost.

The organic acid salt behaves as a core of foaming when the OBSH-based foaming agent foams so that the foaming cell diameter is reduced and the foamed layer that is fine, uniform, and having a large number of foaming cells is obtained.

When any of the above organic acid salts is used, a decomposition residue becomes relatively strongly acidic. Therefore, when the decomposition residue is present in the decoration layer 17 after decomposition of the OBSH-based foaming agent, the decoration layer 17 does not become alkaline, whereby the discoloration of the decoration layer 17 is satisfactorily prevented.

Also, the organic acid salt has a reduction property in addition to the acidic characteristic. Therefore, it is possible to prevent discoloration of the decoration layer 17.

The discoloration of the decoration layer 17 is observed over time after the molding of the opening trim weather strip 10. It is considered that such discoloration is caused because a discoloration substance discoloring the decoration layer 17 is generated to the decoration layer 17 in the course of time.

That is, it is considered that a precursor of the discoloration substance (discoloration substance precursor) is present in the decoration layer 17, and that the discoloration substance precursor is altered into the discoloration substance in the course of time to discolor the decoration layer 17.

Also, as a further consideration over the causes of the generation of the discoloration substance, radicals and the like generated from the decoration layer 17 are considered to be one of the causes. More specifically, it is considered that radicals that are generated in the decoration layer 17 due to the above-described environmental factors and the heat during the molding react with the antioxidant to generate the discoloration substance precursor, and that the discoloration substance precursor reacts with the environmental factors such as NOx to generate the discoloration substance.

Also, it is considered that at least a part of the decoration layer 17 becomes alkaline due to the reaction between the antioxidant or radicals and the environmental factors such as NOx. It is considered that the alkaline effect causes the generation of the discoloration substance to cause the discoloration of the decoration layer 17.

Accordingly, in this invention, the decoration layer 17 contains the organic acid salt that has the acidic characteristics and the reduction property. Therefore, the decoration layer 17 is prevented from discoloration due to the synergy between the acidic characteristics and the reduction property of the organic acid salt of the decoration layer 17 and the non-alkaline decomposition residue of the foaming agent of the decoration layer 17.

At least a part of the decoration layer 17 is formed from an olefin-based thermoplastic elastomer composition. The decoration layer 17 having at least a part formed from the olefin-based thermoplastic elastomer (TPO) is subject to discoloration. It is considered that the discoloration is caused since the decoration layer 17 having the resin component easily generates radicals. Therefore, in this case, it is possible to more prominently exhibit the effect of the organic acid salt for eliminating and/or preventing the discoloration of the decoration layer 17.

The decoration layer 17 contains the antioxidant.

Examples of the antioxidant include a hindered phenol-based antioxidant such as pentaerythritoltetrakis[3-(3,5-di-tert-butyl-4-hydroxyphenyl)propionate (trade name: IRGANOX1010; product of Chiba Specialty Chemicals KK), thiodiethylenebis[3-(3,5-di-tert-butyl-4-hydroxyphenyl)propionate, octadesyl-3-(3,5-di-tert-butyl-4-hydroxyphenyl)propionate, and N,N′-hexane-1,6-diylbis[3-(3,5-di-tert-butyl-4-hydroxyphenyl)propionamide], 2,6-di-tert-butyl-4-methylphenol, and the like. The decoration layer 17 may contain these antioxidants solely or in combination of two or more.

The decoration layer 17 may contain the light stabilizer and/or the ultraviolet absorber.

Examples of the light stabilizer include a hindered amine-based light stabilizer (HALS) such as N,N′,N″,N″-tetrakis-(4,6-bis-(butyl-(N-methyl-2,2,6,6-tetramethylpiperidine-4-yl)amino)-triadine-2-yl)-4,7-diazadecane-1,10-diamine, a polycondensation of dibutylamine-1,3,5-triadine-N,N′-bis(2,2,6,6-tetramethyl-4-piperidyl-1,6-hexamethylenediamine-N-(2,2,6,6-tetramethyl-4-piperidyl)butylamine, poly[{6-(1,1,3,3-tetramethylbutyl)amine-1,3,5-triadine-2,4-diyl}{(2,2,6,6-tetramethyl-4-piperidyl)imino}hexamethylene{(2,2,6,6-tetramethyl-4-piperidyl)imino}], a polymer of dimethyl succinate and 4-hydroxy-2,2,6,6-tetramethyl-1-piperidineethanol, and bis(2,2,6,6-tetramethyl-4-piperidyl)sebacate (trade name: TINUVIN770; product of Chiba Specialty Chemicals KK), and the like. The decoration layer 17 may contain these light stabilizers solely or in combination of two or more.

Examples of the ultraviolet absorber include a benzophenone-based ultraviolet absorber such as 2-hydroxy-4-n-octoxybenzophenone, a benzotriazole-based ultraviolet absorber such as 2-(2-hydroxy-5-methylphenyl)benzotriazole, 2-[2-[hydroxy-3-(3,4,5,6-tetrahydrophthalimide-methyl)-5-methylphenyl]benzotriazole, 2-(3-tert-butyl-2-hydroxy-5-methylphenyl)-5-chlorobenzotriazole (trade name: SUMISORB300; product of Sumitomo Chemical Co., Ltd.), 2-(2-hydroxy-5-tert-octylphenyl)benzotriazole, and 2-(2-hydroxy-3,5-di-tert-pentylphenyl)benzotriazole, a benzoate-based ultraviolet absorber such as 2,4-di-tert-butylphenyl-3,5-di-tert-butyl-4-hydroxybenzoate, and the like. The decoration layer 17 may contain these ultraviolet absorbers solely or in combination of two or more.

Hereinafter, a production method for the opening trim weather strip 10 will be described. FIG. 2 is a schematic diagram showing a part of a production line for the opening trim weather strip 10.

In the opening trim weather strip 10, the weather strip main body 11 and the cover lip 13 are molded by an extrusion molding machine 1. The insert 14 is supplied to the extrusion molding machine 1, and the solid material forming the trim part 12 and the cover lip 13 and the sponge material forming the hollow sealing part 18 are simultaneously extruded by the extrusion molding machine 1 to extrusion-mold the weather strip main body 11. After that, in the case where the materials are rubbers, the weather strip main body 11 is transferred to a high frequency heating furnace, a hot air heating furnace, or the like to be heated and vulcanized.

The vulcanized weather strip 11 is sent to a primary pre-foaming machine 3 as shown in FIG. 2 and bent into a shape having an angle section by a roller of the pre-foaming machine 3 in order to make it easy to perform the surface treatment such as primer coating as well as the attachment of the decoration layer 17.

After the pre-foaming machine 3, the weather strip main body 11 is sent to a surface treatment machine 4. In the case where the adhesion between the weather strip main body 11 and the decoration layer 17 is weak, a surface treatment for reinforcing the fixation of the decoration layer 17 is performed on parts of the upper surface of the trim part 12 and the cover lip 13 to which the decoration layer 17 is fixed.

In the case of forming the weather strip main body 11 from EPDM and forming the decoration layer 17 from the olefin-based thermoplastic elastomer, the surface treatment step may be omitted when the decoration layer 17 can be heat-welded by the EPDM vulcanization heat.

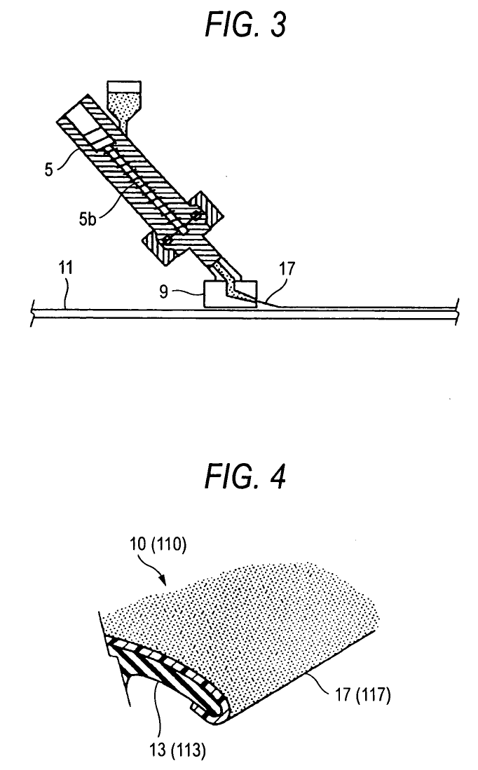

The weather strip main body 11 on which the surface treatment has been performed is sent to an extrusion dice 40 to which a nozzle of an extrusion molding machine 5 is attached. The decoration layer 17 having a color corresponding to an interior of a vehicle is extruded to be in the form of a sheet and on the trim part 12 of the weather strip main body 11 and/or the upper surface of the cover lip 13 by an extrusion dice 9 as described later in this specification (see FIG. 3).

The weather strip main body 11 in which the decoration layer 17 has been extruded on the trim part 12 and/or the upper surface of the cover lip 13 is sent to a lamination machine 6 as shown in FIG. 2 so that the decoration layer 17 is pressed against the weather strip main body 11 by a roller and a pattern is formed on a surface of the decoration layer 17. Further, side ends of the decoration layer 17 are placed under a lower surface of the tip of the cover lip 13 by the roller to pressure-bond the weather strip main body 11 and the decoration layer 17 to each other.

In this case, the weather strip main body 11 is warm due to the vulcanization, and the decoration layer 17 has a high temperature since it has just been extruded. Therefore, in cooperation with the surface treatment effect, such temperatures enable the decoration layer 17 to be firmly attached to the weather strip main body 11.

Further, when both of the materials used for the weather strip main body 11 and the decoration layer 17 are olefin-based materials, such as in the case of forming the weather strip main body 11 from EPDM and forming the decoration layer 17 from the olefin-based thermoplastic elastomer, the decoration layer 17 is more firmly attached to the weather strip main body 11. Also, a secondary bending processing for bending the trim part 12 to form the substantially U-shaped section is performed by the roller of the lamination machine 6.

The opening trim weather strip 10 to which the decoration layer 17 is fixed is sent to a cooling tank 7 to be cooled by water or cold air.

The opening trim weather strip 10 taken out from the cooling tank 7 is drawn by a drawing machine 8 and cut into a predetermined size. After that, a corner part, a terminal part, and the like are molded by using a die so that the opening trim weather strip 10 becomes a product.

Hereinafter, the step for fixing the decoration layer 17 to the weather strip main body 11 by extruding the decoration layer 17 will be described based on FIG. 3.

FIG. 3 is a sectional view showing the step for extrusion-molding the decoration layer 17.

In order to provide the decoration layer 17 on the trim part 12 of the weather strip main body and the upper surface of the cover lip 13, a screw 5b of the extrusion molding machine 5 is rotated as shown in FIG. 3 to extrude the material of the decoration layer 17 to the extrusion dice 9. The extrusion material is extruded from the extrusion dice 9 to be in the form of a sheet having a constant thickness. After that, the surface pattern is formed on the decoration layer 17, and the decoration layer 17 is pressure-bonded to the weather strip main body 11 by the roller in accordance with the shape of the weather strip main body 11 to be attached to the weather strip main body 11 by the lamination machine 6 as described below.

By the roller of the lamination machine 6, the decoration layer 17 is attached to the weather strip main body 11 in such a fashion as to enclose the tip of the cover lip.

Though the example of extruding one layer of the decoration layer 17 from the extrusion dice 40 is described in the foregoing embodiment, two layers of the decoration layer 17 including an adhesive agent layer facing to the weather strip main body may be simultaneously extruded to be attached. In this case, a straight chain low density polyethylene (LLDPE) may be used as the adhesive agent layer.

Also, the surface treatment such as the primer coating described in the foregoing embodiment is not essential and may be omitted. The surface treatment may be substituted by an adhesive agent coating.

What is claimed is:

1. A long molded article comprising a decoration layer of a thermoplastic elastomer foamed material, wherein the decoration layer contains 2 to 10 parts by weight of OBSH-based foaming agent and 3 to 10 parts by weight of an organic acid salt.

2. The long molded article according to claim 1, wherein the thermoplastic elastomer foamed material is molded by extrusion molding and has an average foaming cell diameter of 100 to 300 μm.

3. The long molded article according to claim 1, wherein the organic acid salt is at least one selected from an ascorbic acid salt, an acetic acid salt, a gluconic acid salt, a gultamic acid salt, a malic acid salt and a succinic acid salt.

4. The long molded article according to claim 1, wherein the organic acid salt is sodium acetate.

5. The long molded article according to claim 1, wherein the decoration layer contains the OBSH-based foaming agent in an amount of 4 to 8 parts by weight and the organic acid salt in an amount of 10 to 3 parts by weight, the organic acid salt content being adjusted such that the organic acid salt content is increased when the foaming agent content is small.

6. The long molded article according to claim 1, wherein the decoration layer of the thermoplastic elastomer foamed body is a decoration layer of a vehicle weather strip and provided on a trim part having a substantially U-shaped section of a weather strip main body and/or an upper surface of a cover lip extending from the trim part, and the weather strip main body is formed from EPDM.
